(19) United States
(12) Patent Application Publication
(10) Pub. No.: US 2026/0192561 A1
(43) Pub. Date: Jul. 9, 2026

(54) LIQUID EJECTION APPARATUS AND METHOD OF FORMING CORRECTION PATTERN

(71) Applicant: SEIKO EPSON CORPORATION, Tokyo (JP)

(72) Inventor: Keita KITAZAWA, SHIOJIRI-SHI (JP)

(21) Appl. No.: 19/439,679

(22) Filed: Jan. 5, 2026

(30) Foreign Application Priority Data
Jan. 6, 2025 (JP) 2025-001708

(51) Int. Cl. B41J 2/045; B41J 2/21; B41J 25/00

(52) U.S. Cl. CPC B41J 2/04505; B41J 2/04558; B41J 2/04573; B41J 2/04586; B41J 2/2135; B41J 25/001

(57) ABSTRACT

A liquid ejection apparatus includes a head including a plurality of nozzles that eject a liquid onto a medium to form dots, a moving unit that moves the head in a scanning direction, and a control unit that controls the head to form a correction pattern, wherein the plurality of nozzles form a nozzle row arranged along an intersecting direction intersecting the scanning direction, the correction pattern includes a dummy pattern and a plurality of sub-patterns arranged in the scanning direction, the control unit forms the plurality of sub-patterns by controlling a first timing to cause the nozzle row to eject the liquid and a second timing to cause the nozzle row to eject the liquid, the sub-patterns adjacent to each other in the scanning direction have different intervals between the dots, and the dummy pattern is continuous with an end pattern located at an extreme end in the scanning direction among the plurality of sub-patterns.

The present application is based on, and claims priority from JP Application Serial Number 2025-001708, filed Jan. 6, 2025, the disclosure of which is hereby incorporated by reference herein in its entirety.

### BACKGROUND

### 1. Technical Field

The present disclosure relates to a liquid ejection apparatus and a method of forming a correction pattern.

### 2. Related Art

For example, as in JP-A-2004-330498, there is a printer as an example of a liquid ejection apparatus that prints characters and images on printing paper as an example of a medium. The printer includes a carriage, an ejection head as an example of a head, and a reflective optical sensor. The carriage reciprocates the ejection head and the reflective optical sensor in a main scanning direction.

The ejection head ejects ink as an example of a liquid from a plurality of nozzles. The ejection head performs printing by ejecting ink to form a plurality of dots on the printing paper. The ejection head prints a correction pattern on the printing paper when correcting misalignment of dot formation positions.

The correction pattern includes a plurality of sub-patterns arranged in the main scanning direction. The ejection head prints a plurality of sub-patterns having different densities by changing ejection timing. The reflective optical sensor emits light and receives light reflected by the correction pattern. The reflective optical sensor reads the density of the sub-pattern according to the intensity of the reflected light.

JP-A-2004-330498 is an example of the related art.

For example, when the printing paper is irradiated with ambient light, the reflective optical sensor may receive the light reflected by a portion where the correction pattern is not formed and falsely detect the light.

### SUMMARY

According to an aspect of the present disclosure, there is provided a liquid ejection apparatus including a head having a plurality of nozzles that eject a liquid onto a medium to form dots, a moving unit that moves the head in a scanning direction, and a control unit that controls the head to form a correction pattern, wherein the plurality of nozzles form a nozzle row arranged along an intersecting direction intersecting the scanning direction, the correction pattern includes a dummy pattern and a plurality of sub-patterns arranged in the scanning direction, the control unit forms the plurality of sub-patterns by controlling a first timing to cause the nozzle row to eject the liquid and a second timing to cause the nozzle row to eject the liquid, the sub-patterns adjacent to each other in the scanning direction have different intervals between the dots, and the dummy pattern is continuous with an end pattern located at an extreme end in the scanning direction among the plurality of sub-patterns.

According to another aspect of the present disclosure, there is provided a method of forming a correction pattern for a liquid ejection apparatus including a head having a plurality of nozzles that eject a liquid onto a medium to form dots, and a moving unit that moves the head in a scanning direction, the plurality of nozzles forming a nozzle row arranged along an intersecting direction intersecting the scanning direction, and the method includes forming a plurality of sub-patterns arranged in the scanning direction at intervals between the dots different between the sub-patterns adjacent to each other in the scanning direction by controlling a first timing to cause the nozzle row to eject the liquid and a second timing to cause the nozzle row to eject the liquid, and forming a dummy pattern continuous with an end pattern located at an extreme end in the scanning direction among the plurality of sub-patterns.

### BRIEF DESCRIPTION OF THE DRAWINGS

FIG. 1 is a schematic diagram of one embodiment of a liquid ejection apparatus.

FIG. 2 is a schematic diagram of a correction pattern.

### DESCRIPTION OF EMBODIMENTS

### Embodiments

Hereinafter, one embodiment of a liquid ejection apparatus and a method of forming a correction pattern will be described with reference to the drawings. The liquid ejection apparatus is, for example, an inkjet type printer that performs printing by ejecting ink as an example of a liquid onto a medium such as a paper, a fabric, vinyl, a plastic component, or a metal component.

### Liquid Ejection Apparatus

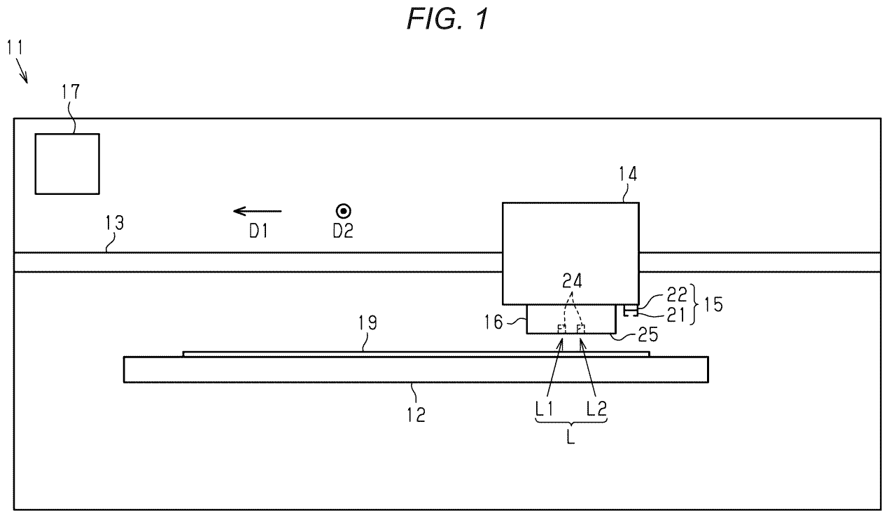

As illustrated in FIG. 1, a liquid ejection apparatus 11 may include a medium support unit 12, a guide shaft 13, a moving unit 14, an optical sensor 15, a head 16, and a control unit 17.

The medium support unit 12 supports a medium 19. The medium support unit 12 may flatly support a part of the conveyed medium 19.

The guide shaft 13 extends in a scanning direction D1. The guide shaft 13 movably supports the moving unit 14.

The moving unit 14 may support the optical sensor 15 and the head 16. The moving unit 14 may reciprocate the optical sensor 15 and the head 16 along the guide shaft 13. That is, the moving unit 14 moves the head 16 in the scanning direction D1. The moving unit 14 reciprocates the head 16 in the scanning direction D1.

The optical sensor 15 includes a diaphragm 21 and a light receiving portion 22. The diaphragm 21 guides light by through an aperture. The diaphragm 21 focuses, for example, light that enters from the outside and is reflected by the medium 19. The range of the light reflected by the medium 19 becomes narrower through the diaphragm 21. The light receiving portion 22 receives the light passing through the aperture of the diaphragm 21.

The head 16 has a plurality of nozzles 24. The head 16 has a nozzle surface 25 in which the plurality of nozzles 24 open. The nozzle surface 25 faces the medium 19 supported by the medium support unit 12.

The nozzles 24 can form dots by ejecting liquid onto the medium 19. The nozzle 24 ejects a droplet as drop-like liquid. The nozzle 24 can continuously eject droplets one by one. The dot is a trace of one droplet adhering to the medium 19.

The plurality of nozzles 24 form a nozzle row L. The plurality of nozzles 24 forming one nozzle row L are arranged along an intersecting direction D2. The nozzle row L extends in the intersecting direction D2. The intersecting direction D2 is a direction different from the scanning direction D1. The intersecting direction D2 is a direction intersecting the scanning direction D1. The intersecting direction D2 and the scanning direction D1 may be directions parallel to the medium 19 supported by the medium support unit 12. The intersecting direction D2 may be a direction in which a conveying unit (not illustrated) conveys the medium 19.

The plurality of nozzles 24 may form a plurality of nozzle rows L. The plurality of nozzle rows L may be arranged in the scanning direction D1 at predetermined distances. The plurality of nozzle rows L include a first nozzle row L1 and a second nozzle row L2. The head 16 of the present embodiment has two nozzle rows L of the first nozzle row L1 and the second nozzle row L2. The first nozzle row L1 and the second nozzle row L2 may eject the same type of liquid. The type of liquid is, for example, a color. The type of liquid is, for example, the type of color material such as a dye or pigment.

The control unit 17 can be configured as a circuit including α: one or more processors that execute various kinds of processing according to a computer program, β: one or more dedicated hardware circuits that execute at least some of the various kinds of processing, or γ: a combination of α and β. The hardware circuit is, for example, an application specific integrated circuit. The processor includes a CPU and a memory such as a RAM and a ROM, and the memory stores program codes or commands configured to cause the CPU to execute processing. The memory, that is, a computer-readable medium includes any readable medium that can be accessed by a general-purpose or dedicated computer.

### Correction Pattern

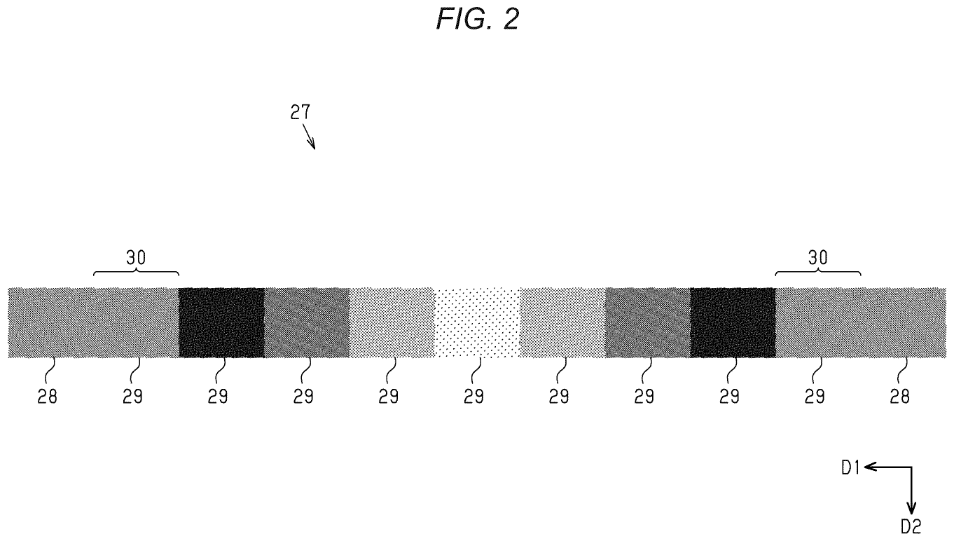

The control unit 17 controls the head 16 to form a correction pattern 27 shown in FIG. 2. The head 16 forms the correction pattern 27 on the medium 19 by ejecting the liquid while moving in the scanning direction D1. The optical sensor 15 reads the correction pattern 27. The optical sensor 15 may receive light that passes over the correction pattern 27 and is reflected by the correction pattern 27.

As illustrated in FIG. 2, the correction pattern 27 includes a dummy pattern 28 and a plurality of sub-patterns 29 arranged in the scanning direction D1. All of the lengths of the sub-patterns 29 in the scanning direction D1 may be the same. In the present embodiment, among the plurality of sub-patterns 29, the sub-patterns 29 located at the extreme ends in the scanning direction D1 are also referred to as end patterns 30. In the present embodiment, the sub-patterns 29 at both ends are respectively referred to as end patterns 30. That is, the correction pattern 27 includes the two end patterns 30.

The correction pattern 27 may include a plurality of the dummy patterns 28. The correction pattern 27 of the present embodiment includes the two dummy patterns 28 respectively corresponding to the two end patterns 30. The dummy pattern 28 is continuous with the end pattern 30. The dummy pattern 28 may be located outside the corresponding end pattern 30 in the scanning direction D1.

The plurality of sub-patterns 29 and the plurality of dummy patterns 28 may have the same size and the same shape. The sub-pattern 29 and the dummy pattern 28 may have different sizes and shapes. One sub-pattern 29 may be larger than the aperture of the diaphragm 21. The area of one sub-pattern 29 may be larger than the aperture area of the diaphragm 21. The sizes of one sub-pattern 29 in the scanning direction D1 and the intersecting direction D2 may be larger than those of the aperture of the diaphragm 21.

The head 16 may form the respective sub-patterns 29 by ejecting the same numbers of droplets to the respective areas where the plurality of sub-patterns 29 are formed. The number of dots forming each sub-pattern 29 may be the same. The head 16 changes the timing at which the first nozzle row L1 and the second nozzle row L2 eject droplets for each sub-pattern 29. Therefore, the sub-patterns 29 adjacent to each other in the scanning direction D1 are different from each other in the overlapping manner of the dots ejected by the first nozzle row L1 and the dots ejected by the second nozzle row L2. The sub-patterns 29 adjacent to each other in the scanning direction D1 have different intervals between the dots ejected by the first nozzle row L1 and the dots ejected by the second nozzle row L2. The sub-patterns 29 adjacent to each other in the scanning direction D1 have different densities.

Specifically, when the intervals between the dots ejected by the first nozzle row L1 and the dots ejected by the second nozzle row L2 are larger, the overlaps between the dots are smaller. Therefore, the wider the range in which the dots are formed, the more the medium 19 is hidden. The sub-pattern 29 having the larger dot intervals has a higher density. When the intervals between the dots ejected by the first nozzle row L1 and the dots ejected by the second nozzle row L2 are smaller, the overlaps between the dots are larger. Therefore, the narrower the range in which the dots are formed, the less the medium 19 is hidden. The sub-pattern 29 having the smaller dot intervals has a lower density. The control unit 17 adjusts so that droplets are ejected from the plurality of nozzle rows at the timing when the sub-pattern 29 having the smallest dot intervals is formed, and thus misalignment of the dot formation positions is reduced and the quality of printing of characters or images on the medium 19 is improved.

In the present embodiment, the plurality of sub-patterns 29 are formed by changing the timing of ejecting droplets from the plurality of nozzle rows within an ideal range of dot intervals corresponding to the resolution for printing characters or images. Therefore, the ideal dot intervals also change depending on the resolution, the combination of timings to be changed changes, and the number of sub-patterns 29 to be formed also changes. In each sub-pattern 29, the dot intervals formed by ejecting droplets from the plurality of nozzle rows are smaller than the ideal dot intervals corresponding to the resolution.

The control unit 17 may form the dummy pattern 28 at the same dot intervals as the end pattern 30. The end pattern 30 and the dummy pattern 28 may have the same density. The control unit 17 may form the end pattern 30 and the dummy pattern 28 with the same number of dots, the same dot size, and the same dot intervals.

The control unit 17 may form the dummy pattern 28 in a different ejection amount from that of the end pattern 30. The control unit 17 may form the end pattern 30 by causing the head 16 to eject a first ejection amount of liquid. The control unit 17 may form the dummy pattern 28 by causing the head 16 to eject a second ejection amount of liquid larger than the first ejection amount. The control unit 17 may increase the ejection amount by increasing the number of droplets to be ejected. The control unit 17 may increase the ejection amount by increasing the size of the droplets. The dummy pattern 28 may have a higher density than the end pattern 30.

### Method of Forming Correction Pattern

The control unit 17 may form the correction pattern 27 on the medium 19 when receiving a correction instruction of the ejection timing. The control unit 17 forms the plurality of sub-patterns 29 by controlling a first timing at which the nozzle row L ejects the liquid and a second timing at which the nozzle row L ejects the liquid. The control unit 17 forms a plurality of dummy patterns 28 continuous with the end patterns 30. The control unit 17 may form the plurality of sub-patterns 29 and the plurality of dummy patterns 28 separately or together.

The nozzle row L may form the plurality of sub-patterns 29 and the plurality of dummy patterns 28 by overlapping second dots formed by ejecting the liquid at the second timing with first dots formed by ejecting the liquid at the first timing. That is, the dot intervals are intervals between the first dots and the second dots. The control unit 17 forms the plurality of sub-patterns 29 arranged in the scanning direction D1 at different dot intervals between the adjacent sub-patterns 29. The control unit 17 may change the movement direction of the nozzle row L and the head 16 that eject the liquid according to an object to be corrected.

Correction of Dot Misalignment between Forward Path and Backward Path

The control unit 17 causes the head 16 to reciprocate in the scanning direction D1 and causes one nozzle row L to eject the liquid in each of the forward path and the backward path. Ejecting droplets from the nozzle row L in the forward path and the nozzle row Lin the backward path corresponds to ejecting droplets from a plurality of nozzle rows. For example, the control unit 17 may cause the first nozzle row L1 to eject the liquid at the first timing in the forward path. In the forward path, the first nozzle row L1 may eject droplets at regular intervals from the positions of one end to the positions of the other end of the plurality of sub-patterns 29 arranged in the scanning direction D1.

The control unit 17 may form the dummy pattern 28 together with the sub-pattern 29. In this case, in the forward path, the first nozzle row L1 may eject droplets at regular intervals from the position of one end to the position of the other end of the correction pattern 27.

Subsequently, the control unit 17 causes the first nozzle row L1 to eject the liquid at the second timing in the backward path. The second timing is different from the first timing. Specifically, the first nozzle row L1 makes the ejection timing different for each sub-pattern 29 in the backward path. The first nozzle row L1 may form the dummy pattern 28 by ejecting droplets at the same ejection intervals as those in the forward path while ejecting droplets from the position of the other end to the position of the one end of the correction pattern 27 in the backward path, or may change the ejection intervals at the boundary between the sub-patterns 29.

Correction of Dot Misalignment between Nozzle Rows

The control unit 17 causes the plurality of nozzle rows L to eject the liquid while the head 16 moves in one direction. For example, in the movement of the head 16 in the scanning direction D1, the control unit 17 may form the plurality of sub-patterns 29 by causing the first nozzle row L1 to eject the liquid at the first timing and causing the second nozzle row L2 to eject the liquid at the second timing. The first timing and the second timing are the same as those of the correction of dot misalignment between the forward path and the backward path. The dummy pattern 28 may be formed by causing the first nozzle row L1 and the second nozzle row L2 to eject the liquid. Ejecting droplets from the first nozzle row L1 and the second nozzle row L2 corresponds to ejecting droplets from a plurality of nozzle rows.

### Functions of Present Embodiment

Functions of the present embodiment will be described.

The control unit 17 forms one or more correction patterns 27 according to an object to be corrected. The control unit 17 may form the correction pattern 27 on a white medium 19 with a black liquid. The control unit 17 causes the optical sensor 15 to read the formed correction pattern 27.

The sub-pattern 29 having a higher density hardly reflects light. The sub-pattern 29 having a lower density easily reflects light. Therefore, the intensity of the light received by the optical sensor 15 changes depending on the density of the sub-pattern 29 to be read. For example, the control unit 17 may correct the ejection timing of the droplets in accordance with the sub-pattern 29 that has returned the strongest light.

The dummy pattern 28 is less likely to reflect light than the medium 19. Therefore, when the optical sensor 15 reads the end pattern 30, the influence of light reflected around the end pattern 30 is reduced.

### Effects of Present Embodiment

Effects of the present embodiment will be described.

(1-1) In the plurality of sub-patterns 29 arranged in the scanning direction D1, the end patterns 30 located at the extreme ends are most easily affected by ambient light. In this regard, the dummy patterns 28 are located next to the end patterns 30. By suppressing the reflection of the ambient light by the dummy patterns 28, the influence of the ambient light can be reduced.

(1-2) The dot intervals of the dummy pattern 28 is the same as the dot intervals of the adjacent end pattern 30. The load on the control unit 17 can be reduced by making the dot intervals equal.

(1-3) The liquid ejected to form the dummy pattern 28 is more than the liquid ejected to form the end pattern 30. Therefore, the density of the dummy pattern 28 can be made higher than the density of the end pattern 30. By making the density of the dummy pattern 28 higher, the light reflected by the dummy pattern 28 can be further reduced.

(1-4) In the optical sensor 15, the light receiving unit 22 receives the light passing through the diaphragm 21. The aperture of the diaphragm 21 is smaller than the sub-pattern 29. Therefore, the possibility that the light receiving unit 22 receives the light reflected by other than the sub-pattern 29 can be reduced.

(1-5) The control unit 17 forms the plurality of sub-patterns 29 by ejecting the liquid in the forward path and the backward path. Therefore, it is possible to form the correction pattern 27 for correcting misalignment between the dots formed in the forward path and the dots formed in the backward path.

(1-6) The control unit 17 forms the plurality of sub-patterns 29 by causing the first nozzle row L1 and the second nozzle row L2 to eject the liquid at different timings. Therefore, it is possible to form the correction pattern 27 for correcting the dot misalignment in the plurality of nozzle rows L.

(1-7) The liquid ejected by the first nozzle row L1 is the same as the liquid ejected by the second nozzle row L2. By correcting the misalignment between the dots formed by the first nozzle row L1 and the dots formed by the second nozzle row L2, for example, it is possible to improve the accuracy of forming one dot by superimposing the dot formed by the second nozzle row L2 on the dot formed by the first nozzle row L1.

### Modifications

The present embodiment can be modified and implemented as described below. The present embodiment and the following modifications can be implemented in combination with each other as long as no technical inconsistencies are involved.

The head 16 may form the dummy pattern 28 using the same nozzle row L as the nozzle row L forming the sub-pattern 29. The head 16 may form the dummy pattern 28 using one or more nozzle rows L. The head 16 may form the dummy pattern 28 by causing the plurality of nozzle rows L including the nozzle row L forming the sub-pattern 29 and the nozzle row L not used for forming the sub-pattern 29 to eject the liquid. The head 16 may form the dummy pattern 28 by causing one or more nozzle rows L different from the nozzle row L forming the sub-pattern 29 to eject the liquid.

The head 16 may have one nozzle row L.

The head 16 may have three or more nozzle rows L. At least two of the plurality of nozzle rows L may eject different types of liquids.

The first nozzle row L1 and the second nozzle row L2 may eject different types of liquids.

The control unit 17 may form the sub-pattern 29 and the dummy pattern 28 using different types of liquids. For example, the control unit 17 may form the sub-pattern 29 by ejecting color ink. The control unit 17 may form the dummy pattern 28 by ejecting black ink. The pattern formed by the black ink is less likely to reflect light than the pattern formed by the color ink. Therefore, it is possible to reduce false detection of the optical sensor 15 as compared with a case where the dummy pattern 28 is formed with the same color ink as that of the sub-pattern 29.

The dummy pattern 28 may be adjacent to the end pattern 30 in the intersecting direction D2. The dummy pattern 28 may be in contact with one or more sides of a rectangular sub-pattern 29. The dummy pattern 28 may surround the sub-pattern 29. The dummy pattern 28 may also be in contact with the sub-pattern 29 different from the end pattern 30.

The correction pattern 27 may include one dummy pattern 28. For example, the control unit 17 may form the dummy pattern 28 continuously from the end pattern 30 located at a position easily affected by ambient light.

The optical sensor 15 may be provided in an apparatus different from the liquid ejection apparatus 11. A user may cause, for example, a scanner including the optical sensor 15 to read the medium 19 on which the correction pattern 27 is formed. The correction pattern 27 may be read by the user.

The liquid ejection apparatus 11 may include an irradiation unit that emits light. The light receiving unit 22 may receive light emitted from the irradiation unit and reflected by the sub-pattern 29. The optical sensor 15 may include the irradiation unit that emits light. The optical sensor 15 may have a configuration in which the light receiving unit 22 receives reflected light of light emitted by the irradiation unit provided therein.

The optical sensor 15 may not include the diaphragm 21.

The size of the sub-pattern 29 may be the same as the size of the aperture of the diaphragm 21. The size of the sub-pattern 29 may be smaller than the aperture of the diaphragm 21.

The control unit 17 may form the end pattern 30 and the dummy pattern 28 by causing the head 16 to eject the same amounts of liquid.

The control unit 17 may make the dot intervals of the end pattern 30 different from the dot intervals of the dummy pattern 28. The dot intervals of the dummy pattern 28 may be made smaller than the dot intervals of the end pattern 30.

The liquid ejection apparatus 11 may be a liquid ejection apparatus that sprays or ejects a liquid other than ink. The state of the liquid to be ejected as a minute amount of droplet from the liquid ejection apparatus includes a particle state, a teardrop state, and a state of tailing like a thread. The liquid mentioned here may sufficiently be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include such ink as described in the above embodiment and a liquid crystal. Here, the term ink includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curable resin onto a substrate in order to form a minute hemispherical lens used for an optical communication element or the like, an optical lens, or the like. The liquid ejection apparatus may be an apparatus that ejects an acid or alkali etching solution in order to etch a substrate or the like.

### Definitions

The expression “at least one” used in this specification means “one or more” of desired options. For example, the expression “at least one” used in the present specification means “either one of alternatives” or “both of two alternatives” when the number of the alternatives is two. As another example, the expression “at least one” used in the present specification means “just one alternative,” “a combination of any two alternatives”, or “a combination of any three or more alternatives” when the number of alternatives is three or more.

### Appendices

Technical ideas grasped from the embodiments and the modifications explained above and action effects of the technical ideas are described below.

[1] A liquid ejection apparatus includes a head having a plurality of nozzles that eject a liquid onto a medium to form dots, a moving unit that moves the head in a scanning direction, and a control unit that controls the head to form a correction pattern, wherein the plurality of nozzles form a nozzle row arranged along an intersecting direction intersecting the scanning direction, the correction pattern includes a dummy pattern and a plurality of sub-patterns arranged in the scanning direction, the control unit forms the plurality of sub-patterns by controlling a first timing to cause the nozzle row to eject the liquid and a second timing to cause the nozzle row to eject the liquid, the sub-patterns adjacent to each other in the scanning direction have different intervals between the dots, and the dummy pattern is continuous with an end pattern located at an extreme end in the scanning direction among the plurality of sub-patterns.

In the plurality of sub-patterns arranged in the scanning direction, the end pattern located at the extreme end is easily affected by ambient light. In this regard, according to the configuration, the dummy pattern is located adjacent to the end pattern. By suppressing the reflection of the ambient light by the dummy pattern, the influence of the ambient light can be reduced.

[2] In the liquid ejection apparatus according to [1], the control unit may form the dummy pattern at same intervals between dots as those of the end pattern.

According to the configuration, the intervals between the dots of the dummy pattern are the same as the intervals between the dots of the adjacent end pattern. The load on the control unit can be reduced by making the intervals between the dots equal.

[3] In the liquid ejection apparatus according to [1] or [2], the control unit may cause the head to eject a first ejection amount of the liquid to form the end pattern, and cause the head to eject a second ejection amount of the liquid larger than the first ejection amount to form the dummy pattern.

According to the configuration, the liquid ejected to form the dummy pattern is larger in amount than the liquid ejected to form the end pattern. Therefore, the density of the dummy pattern can be made higher than the density of the end pattern. By increasing the density of the dummy pattern, light reflected by the dummy pattern can be further reduced.

[4] The liquid ejection apparatus according to any one of [1] to [3] described above may further include an optical sensor that reads the correction pattern, wherein the optical sensor may include a diaphragm that guides light through an aperture, and a light receiving unit that receives the light passing through the aperture, and the control unit may form the sub-pattern larger than the aperture.

According to the configuration, in the optical sensor, the light receiving unit receives the light passing through the diaphragm. The aperture of the diaphragm is smaller than the sub-pattern. Therefore, the possibility that the light receiving unit receives the light reflected by other than the sub-pattern can be reduced.

[5] In the liquid ejection apparatus according to any one of [1] to [4], the moving unit may reciprocate the head in the scanning direction, and the control unit may cause the nozzle row to eject the liquid at the first timing in a forward path and causes the nozzle row to eject the liquid at the second timing in a backward path.

According to the configuration, the control unit forms the plurality of sub-patterns by ejecting the liquid in the forward path and the backward path. Therefore, it is possible to form the correction pattern for correcting misalignment between the dots formed in the forward path and the dots formed in the backward path.

[6] In the liquid ejection apparatus according to any one of [1] to [5] described above, the plurality of nozzles may form a first nozzle row and a second nozzle row arranged in the scanning direction at a predetermined distance, and, in the movement of the head in the scanning direction, the control unit may cause the first nozzle row to eject the liquid at the first timing and cause the second nozzle row to eject the liquid at the second timing to form the plurality of sub-patterns.

According to the configuration, the control unit forms the plurality of sub-patterns by causing the first nozzle row and the second nozzle row to eject the liquid at different timings. Therefore, it is possible to form the correction pattern for correcting the dot misalignment in the plurality of nozzle rows.

[7] In the liquid ejection apparatus according to [6], the first nozzle row and the second nozzle row may eject a same type of liquid.

According to the configuration, the liquid ejected by the first nozzle row is the same as the liquid ejected by the second nozzle row. By correcting the misalignment between the dots formed by the first nozzle row and the dots formed by the second nozzle row, for example, it is possible to improve the accuracy of forming one dot by superimposing the dot formed by the second nozzle row on the dot formed by the first nozzle row.

[8] A method of forming a correction pattern for a liquid ejection apparatus including a head having a plurality of nozzles that eject a liquid onto a medium to form dots, and a moving unit that moves the head in a scanning direction, the plurality of nozzles forming a nozzle row arranged along an intersecting direction intersecting the scanning direction, the method includes forming a plurality of sub-patterns arranged in the scanning direction at intervals between the dots different between the sub-patterns adjacent to each other in the scanning direction by controlling a first timing to cause the nozzle row to eject the liquid and a second timing to cause the nozzle row to eject the liquid, and forming a dummy pattern continuous with an end pattern located at an extreme end in the scanning direction among the plurality of sub-patterns.

According to the method, it is possible to achieve substantially the same effects as those of the liquid ejection apparatus described above.

What is claimed is:

1. A liquid ejection apparatus comprising:
a head having a plurality of nozzles that eject a liquid onto a medium to form dots;
a moving unit that moves the head in a scanning direction; and
a control unit that controls the head to form a correction pattern, wherein
the plurality of nozzles form a nozzle row arranged along an intersecting direction intersecting the scanning direction,
the correction pattern includes a dummy pattern and a plurality of sub-patterns arranged in the scanning direction,
the control unit forms the plurality of sub-patterns by controlling a first timing to cause the nozzle row to eject the liquid and a second timing to cause the nozzle row to eject the liquid,
the sub-patterns adjacent to each other in the scanning direction have different intervals between the dots, and
the dummy pattern is continuous with an end pattern located at an extreme end in the scanning direction among the plurality of sub-patterns.

2. The liquid ejection apparatus according to claim 1, wherein
the control unit forms the dummy pattern at same intervals between dots as those of the end pattern.

3. The liquid ejection apparatus according to claim 1, wherein
the control unit causes the head to eject a first ejection amount of the liquid to form the end pattern, and causes the head to eject a second ejection amount of the liquid larger than the first ejection amount to form the dummy pattern.

4. The liquid ejection apparatus according to claim 1, further comprising an optical sensor that reads the correction pattern, wherein
the optical sensor includes:
a diaphragm that guides light through an aperture; and
a light receiving unit that receives the light passing through the aperture, and
the control unit forms the sub-pattern larger than the aperture.

5. The liquid ejection apparatus according to claim 1, wherein
the moving unit reciprocates the head in the scanning direction, and
the control unit causes the nozzle row to eject the liquid at the first timing in a forward path and causes the nozzle row to eject the liquid at the second timing in a backward path.

6. The liquid ejection apparatus according to claim 1, wherein
the plurality of nozzles form a first nozzle row and a second nozzle row arranged in the scanning direction at a predetermined distance, and
in the movement of the head in the scanning direction, the control unit causes the first nozzle row to eject the liquid at the first timing and causes the second nozzle row to eject the liquid at the second timing to form the plurality of sub-patterns.

7. The liquid ejection apparatus according to claim 6, wherein
the first nozzle row and the second nozzle row eject a same type of liquid.

8. A method of forming a correction pattern for a liquid ejection apparatus including a head having a plurality of nozzles that eject a liquid onto a medium to form dots, and a moving unit that moves the head in a scanning direction, the plurality of nozzles forming a nozzle row arranged along an intersecting direction intersecting the scanning direction, the method comprising:
forming a plurality of sub-patterns arranged in the scanning direction at intervals between the dots different between the sub-patterns adjacent to each other in the scanning direction by controlling a first timing to cause the nozzle row to eject the liquid and a second timing to cause the nozzle row to eject the liquid; and
forming a dummy pattern continuous with an end pattern located at an extreme end in the scanning direction among the plurality of sub-patterns.
